(19) United States
(12) Patent Application Publication
(10) Pub. No.: US 2010/0104488 A1
(43) Pub. Date: Apr. 29, 2010

(54) Multi-Dosing Detergent Delivery Device

(75) Inventors: Chris Efstathios Housmekerides, Wassenaar (NL); Karl Ludwig Gibis, Limburgerhof (DE); Edmond Cheung, Shenzhen City (CN); John Lung, Shenzhen City (CN); Bt Ram, Shenzhen City (CN)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N., Hoofddorp (NL)

(21) Appl. No.: 12/447,571

(22) PCT Filed: Oct. 29, 2007
(86) PCT No.: PCT/GB07/04103

§ 371 Date: Nov. 23, 2009

(30) Foreign Application Priority Data
Oct. 30, 2006 (GB) 0621574.3
Aug. 17, 2007 (GB) 0716054.2

(51) Int. Cl. B01D 11/02; B08B 3/00

(52) U.S. Cl. 422/261; 68/17 R; 134/93

(57) ABSTRACT

The invention relates to a multi-dosing detergent delivery device. The device comprises a housing (20) for receiving therein a cartridge (50, 5000) having a plurality X of chambers (52) each accommodating a detergent composition; a water/wash liquor collection area (360) for receiving and collecting water/wash liquor falling upon it; directing means (350) for directing said water/wash liquor selectively into an inlet hole of a chamber (52) of the cartridge (50, 5000) to contact the detergent composition therein; and an (220) outlet to allow the detergent loaded wash liquor to exit the device. The device further comprises manually operated indexing means (380) for causing movement of said directing means relative to said cartridge (50, 5000) so as to cause sequential movement of said directing means from directing water/wash liquor from one chamber (52) to directing it to a neighbouring chamber (52) and wherein means are provided for maintaining said push button in a “Down” state once it has been depressed and a return means for restoring said push button to an “up” state after a washing cycle has been commenced.

The invention relates to a multi-dosing detergent delivery device. The device is particularly for dispensing said detergent into an automatic dishwashing or washing machine over a plurality of washing cycles.

In automatic dishwashing machines, the detergent, whether in powder, tablet or gel form, is usually filled manually by the user into the machine, in particular into a detergent holder, before each dishwashing operation.

This filling process is inconvenient, with the problem of exact metering of the detergent and possible spillage thereof, for powder and gel detergents. Even with detergents in tablet form, wherein the problem of accurate dosing is overcome, there is still the necessity of handling the dishwashing detergent every time a dishwashing cycle is started. This is inconvenient because of the usually corrosive nature of dishwasher detergent compositions.

A number of devices are known for holding unit doses of a detergent composition or additive, such as detergent tablets, and for dispensing of such unit doses into a machine.

WO 01/07703 discloses a device for the metered release of a detergent composition or additive into a dishwashing machine having a number of separate sealed chambers for holding the detergent composition or additive and means for piercing the chambers, activated by conditions within the machine.

WO 03/073906 discloses a free standing device for dispensing multiple doses of detergent into a dishwasher. The device has a plate-like construction. A round blister pack having a plurality of doses arranged around its periphery is loaded into the pack. A winder is then rotated to load mechanical energy into the device sufficient to dispense more than one dose of detergent. A thermally operated latch then moves when the device is subjected to the elevated temperatures within the dishwasher and, in cooperation with a ratchet mechanism, moves the blister pack so that the next dose of detergent is ready for dispensing. In order to dispense the detergent, either the blister pack is pierced, or the dose is ejected from its compartment within the blister pack.

WO 03/073907 discloses a similarly shaped free standing dispensing device. In order to dispense detergent, a lever is manually operated to move a blister pack either to eject the detergent from a compartment within the blister pack, or to pierce the blister pack. A door or flap initially prevents wash liquor within the machine from accessing the exposed detergent. A bi-metallic strip is provided to move the door or flap when the device is exposed to the elevated temperatures during a washing cycle to allow access of the wash liquor to the exposed detergent thereby dispensing the detergent to the machine.

With manually operated (e.g. push-button) devices, there remains a problem of how to prevent a user from re-activating a push button of the device a second time prior to using the device (which would cause the device to lose synchronisation and index beyond a usable detergent dose position). It would also be desirable to remove the temptation of a seemingly “unpushed” button, so that double activation is not possible.

It is therefore an aim of embodiments of the invention to solve or reduce the problem of double activation.

According to the present invention there is provided multi-dosing detergent delivery device, the device comprising: a housing for receiving therein a cartridge having a plurality X of chambers each accommodating a detergent composition; a water/wash liquor collection area for receiving and collecting water/wash liquor falling upon it; directing means for directing said water/wash liquor selectively into an inlet hole of a chamber of the cartridge to contact the detergent composition therein; and an outlet to allow the detergent loaded wash liquor to exit the device, the device further comprising push button operated indexing means for causing movement of said directing means relative to said cartridge so as to cause sequential movement of said directing means from directing water/wash liquor from one chamber to directing it to a neighbouring chamber and wherein means are provided for maintaining said push button in a “Down” state once it has been depressed and a return means for restoring said push button to an “Up” state after a washing cycle has been commenced.

Preferably, said means for maintaining said push button in said “Down” state comprises a first member associated with said push button and a second member associated with a chassis member of said device.

Preferably, said means for maintaining said push button in a “Down” state comprises latching means.

Preferably, said latching means comprises the co-operation of a leg of said push button with a protuberance formed on a chassis member of the device.

Said return means may comprise a thermally activated member which, when heated to an activation temperature, acts to defeat said latching means and return said push button to an “Up” state.

Preferably, said thermally activated member comprises a Shape Memory Alloy member which suitably is formed as resilient biasing means to provide a return spring mechanism that expands upon heating to cause said push button to return to an “Up” state.

Alternatively, said means for maintaining said push button in said “Down” state may comprise first and second magnetic or magnetisable members.

Here, said first magnetic or magnetisable member is preferably associated, with said push button and the second magnetic or magnetisable member is associated with the chassis member.

Preferably, one of said first or second magnetic or magnetisable members comprises a thermo-sensitive magnetic member and the other of said first or second magnetic members comprises either a permanent magnet or a ferro-magnetic material.

Said thermo-sensitive magnetic member may be arranged so as to be magnetically attracted to said permanent magnet/ferro-magnetic material at room temperature ranges, but to have reduced magnetic attraction at higher temperatures commonly encountered during washing cycles.

Preferably, said thermo-sensitive magnetic member has a Curie point at approximately 43 degrees Celcius.

The return means may suitably comprise spring return means for returning said push button to the “Up” state when there is reduced magnetic attraction between said first and second magnetic or magnetisable members.

Preferably, the device further comprises an end stop mechanism for preventing actuation of said manual indexing mechanism subsequent to an X^{th} washing cycle.

Preferably, said manually operated indexing means comprise a push button, wherein following an X^{th} washing cycle said push button is blocked by action of said end stop Mechanism to prevent it from being pushed.

Said manually, operated indexing means may further comprise a dial and wherein said push button and indicator dial have slots and ribs which, when aligned, allow said push button to descend.

Preferably, following said 1^{st} through (X−1)^{th} washing cycles, said ribs and slots are brought into alignment by said indexing mechanism, but following said X^{th} washing cycle said end stop mechanism acts so as to cause said ribs and slots to be out of alignment.

Preferably, said push button is arranged for up and down movement only in a first plane, whilst said dial is arranged only for rotational movement in a plane perpendicular to the first plane and on a rotational axis centred upon the central axis of said push button.

Said end stop mechanism suitably comprises a first end stop member which moves in concert with said dial and a second end stop member that is static, wherein following an Xth washing cycle said first and second end stop members come into abutment to halt said rotational movement at position where said ribs and slots are out of alignment.

Said first end stop member and said second end stop member are preferably arranged so as to prevent further relative movement between said cartridge and said directing means.

Preferably, said end stop mechanism acts to cause the push button to be blocked in an “Up” state after said X^{th} washing cycle.

Preferably, said indexing mechanism operates such that when the push button is depressed from an “Up” state to bring it into a “Down” state ready for a next washing cycle, depressing said push button causes said directing means to rotate and move from being in alignment with one chamber to being in alignment with a next chamber as said push button is depressed to be in a “Down” state.

Said indexing mechanism suitably operates so as to cause said dial to rotate and move from indicating that one chamber is being utilised to indicating that a next chamber is to be utilised following the return of the push button to an “Up” state from a “Down” state.

Preferably, depressing said push button causes said indexing mechanism to advance said directing means rotationally by an angle of (360/X).

Preferably, the return of said push button from an activated “Down” state to an “Up” state, for each washing cycle from a 1^{st} through (X−1)^{th} washing cycle, causes rotational movement of said dial to advance said dial by an angle of (360/X), whereas the return of said push button from an activated “Down” state to an “Up” state from a final, X^{th}, washing cycle causes said dial to advance by an angle of <(360/X).

Preferably, said indexing mechanism comprises a pawl attached to said push button and a helix for rotating said directing means by mutual engagement with said pawl each time said push button is depressed.

Said indexing mechanism preferably comprises a latching means for maintaining said push button in a “Down” state once it has been depressed and a return means for overcoming said latching means after a washing cycle has been commenced.

Said latching means may comprise the co-operation of a leg of said push button with a protuberance formed on a chassis member of the device.

Preferably, the chassis member forms a static support for the directing means.

Preferably, said indexing mechanism further comprises detent means for positively locating the directing means at a location in which the directing means is aligned with a chamber inlet each time that the indexing means is actuated.

Said directing means may be provided with a plurality of detent means spaced around a periphery thereof and said detent means is arranged to co-operate with a resiliently biased arm of said device.

Said resiliently biased arm may comprise a part of a chassis member of said device.

Preferably, said detent means is arranged to prevent backward rotation of said directing means.

Preferably, said detent means is arranged to block backward rotation of said directing means during a transition from a push button “Down” state to a push button “Up” state.

Most preferably, end stop mechanism is released by a user detaching an upper portion of said device from a lower portion of the device. Preferably, detaching an upper portion of said device from a lower portion of said device frees a first end stop member of said end stop mechanism from a second member of said end stop mechanism.

Preferably, separating the upper portion from the lower portion allows a user to insert a new refill cartridge into the device.

Preferably, said housing is substantially cylindrical and each compartment occupies a nominal 360/X angular degrees of space.

Preferably, said indexing mechanism contains a thermally activated element. Whilst the thermally activated element may be any of a wax motor, memory metal/memory alloy, thermal bimetal, bimetal snap element or shape memory polymer, it is most preferably a memory metal/shape memory alloy. The thermally activated element is preferably designed to react at a temperature between 25° C. and 55° C. (more preferably approximately 50° C.).

Preferably, the directing means comprises a funnel of said device.

The device is preferably for use in an automatic dishwasher. Accordingly the detergent most preferably comprises an automatic dishwasher detergent. Examples of which include conventional detergents, and the ‘2-in-1’ and ‘3-in-1’ variants. Most preferably the detergent comprises a solid. In the context of the present invention the term solid can be taken to include solidified gels as well as conventional solid materials (such as compressed particulate materials and solidify molten/cross linked materials).

The detergent formulation typically comprises one or more of the following components; builder, co-builder, surfactant, bleach, bleach activator, bleach catalyst, enzyme, polymer, dye, pigment, fragrance, water and organic solvent.

Optionally the detergent comprises a detergent additive. It will be appreciated that a detergent additive when compared to a detergent may be required during a different section of the dishwasher wash cycle (e.g. such as the rinse cycle for a rinse aid detergent additive).

The detergent may be added to the cartridge by any suitable method. The detergent may be added to the cartridge manually, by casting or by injection moulding.

A suitable injection moulding process is described in British Patent Application GB-A-2 406 821 and WO 2005/035709.

Preferably the device includes an indication mechanism to show how many chambers of the cartridge remain (i.e. are still full of detergent) or how many of the chambers have been used up so that a user has an idea of when a replacement is required. A preferred form of an indication mechanism comprises a marking on the dial which can be viewed by a consumer either through a bezel portion of the device or directly. The marking may comprises a series of numerals arranged in association with one or more of the chambers of the cartridge. Such a marking may require a window in order to be viewed by a consumer. Optionally the marking may be associated with a fixed marker so that the relevant part of the marking is clearly indicated.

Optionally the marking may employ a colour scheme (e.g. along the lines of a traffic light system with red meaning that only a small number of chambers remain, yellow an intermediate number and green a large number of chambers remain.

Examples of devices in accordance with the present invention will now be described with reference to the accompanying drawings, in which:

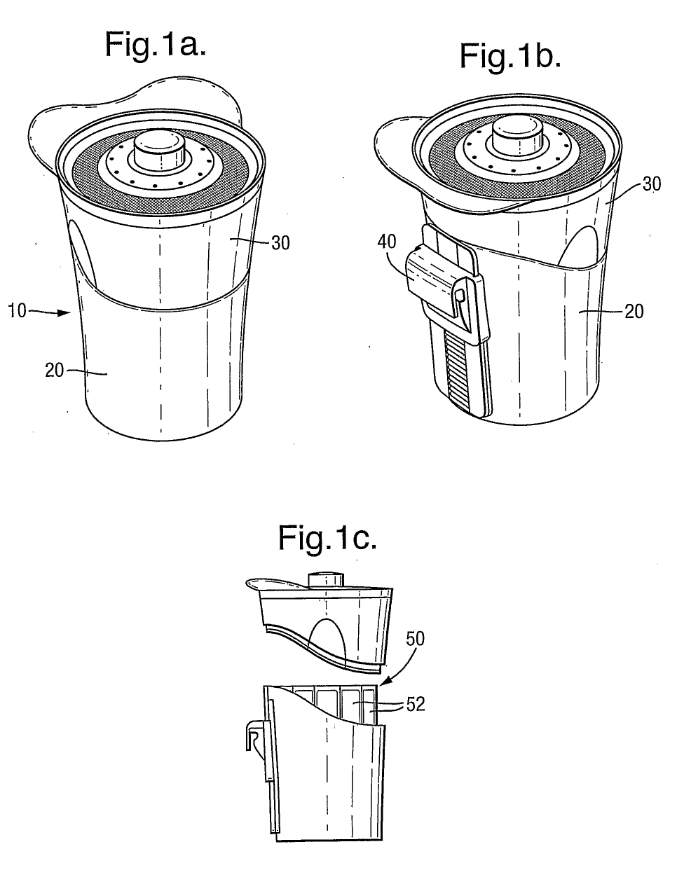

FIGS. 1(a), 1(b) and 1(c) show respectively assembled perspective front views, side view and a view with lid portion removed of a detergent dispensing device according to an embodiment of the invention;

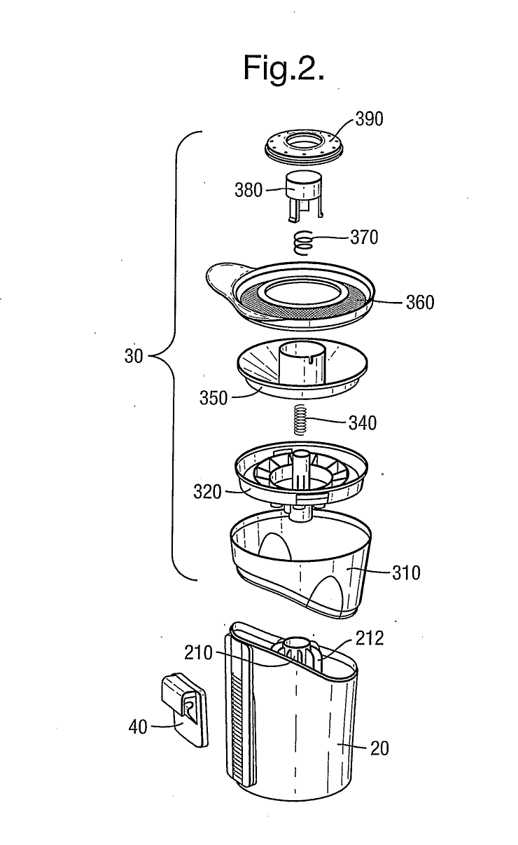

FIG. 2 is an exploded view of the device of FIG. 1;

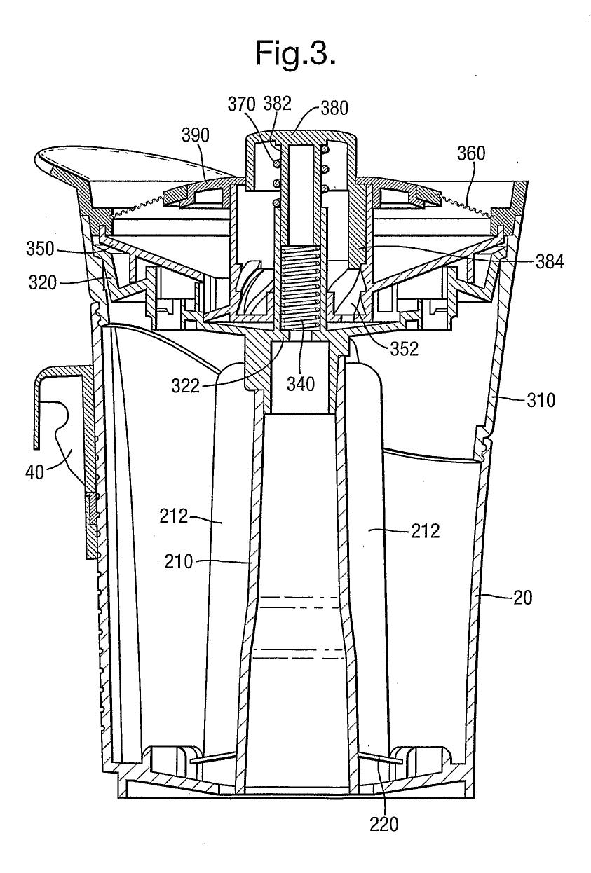

FIG. 3 is a cross-sectional view of the device of FIGS. 1 and 2;

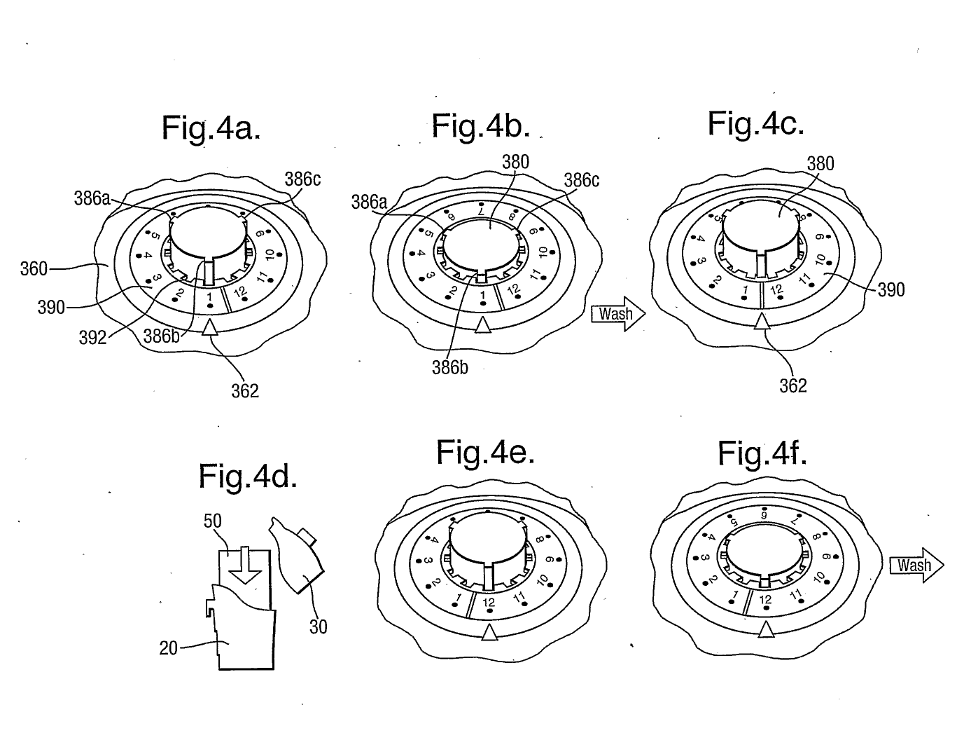

FIGS. 4(a) through 4(f) show a story board illustrating advancement of an end of life mechanism of the device of FIGS. 1 to 3;

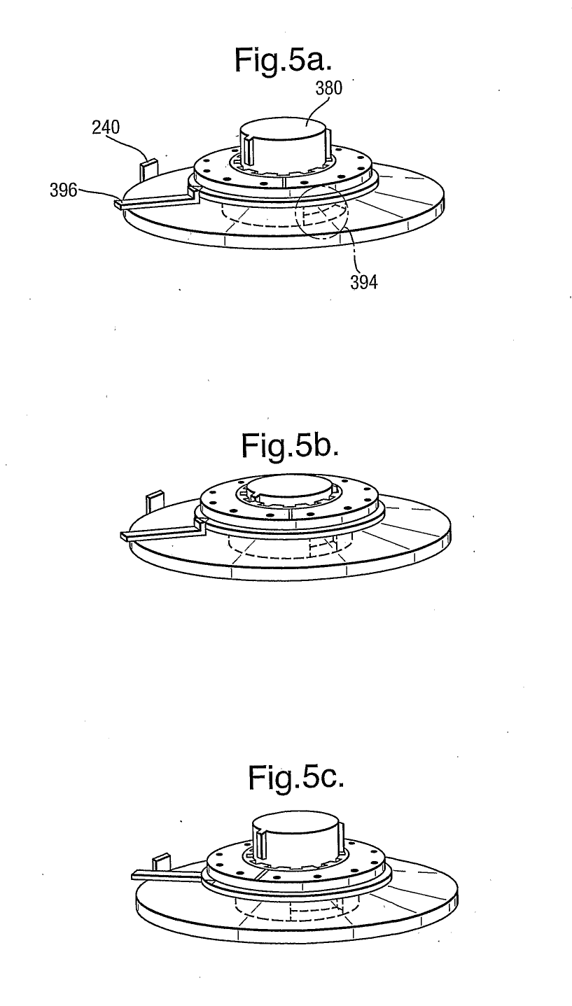

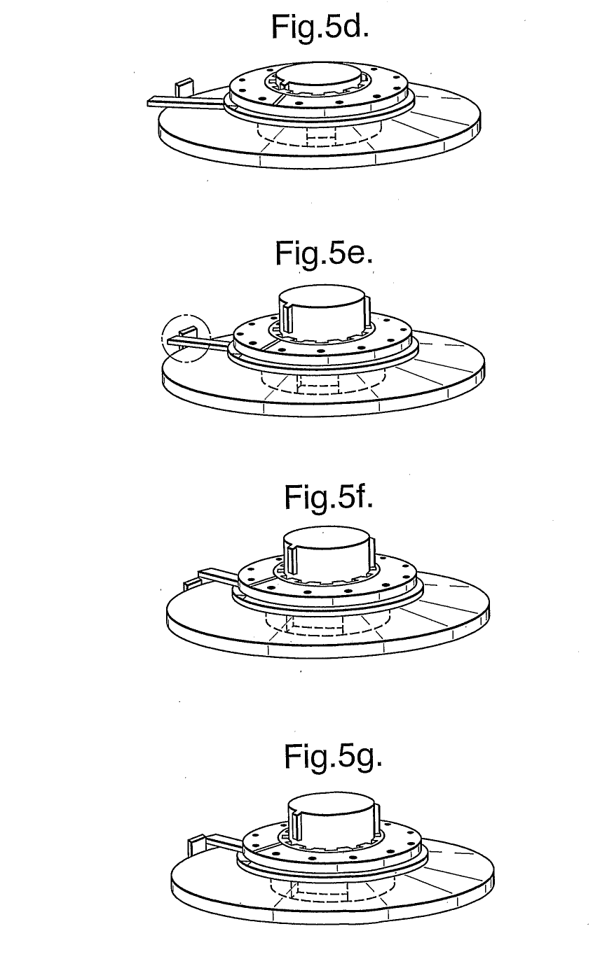

FIGS. 5(a) through 5(g) are part sectional views, illustrating a story board for movement of an end of life mechanism of a device similar to the device of FIGS. 1 to 4;

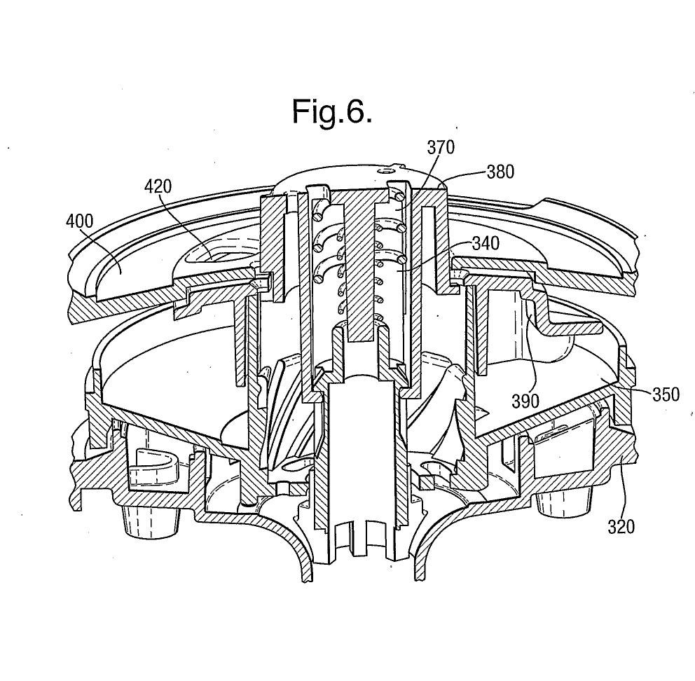

FIG. 6 is a part sectional view of a further embodiment of the device showing an advance mechanism for the device and movement of an end of life indicator;

FIG. 7 is a view of the embodiment of FIG. 6, with a upper most lid portion removed so as to reveal internal workings of the device;

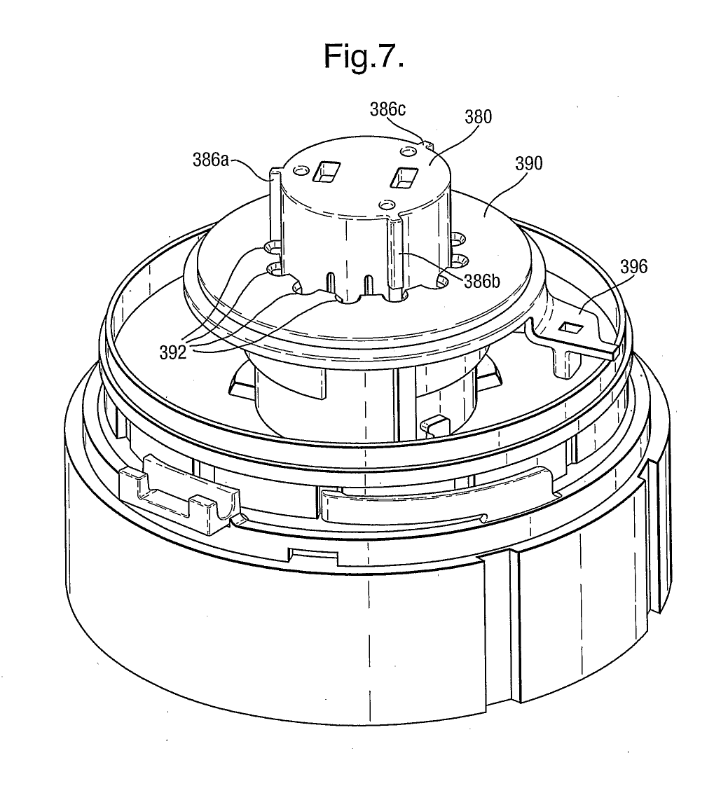

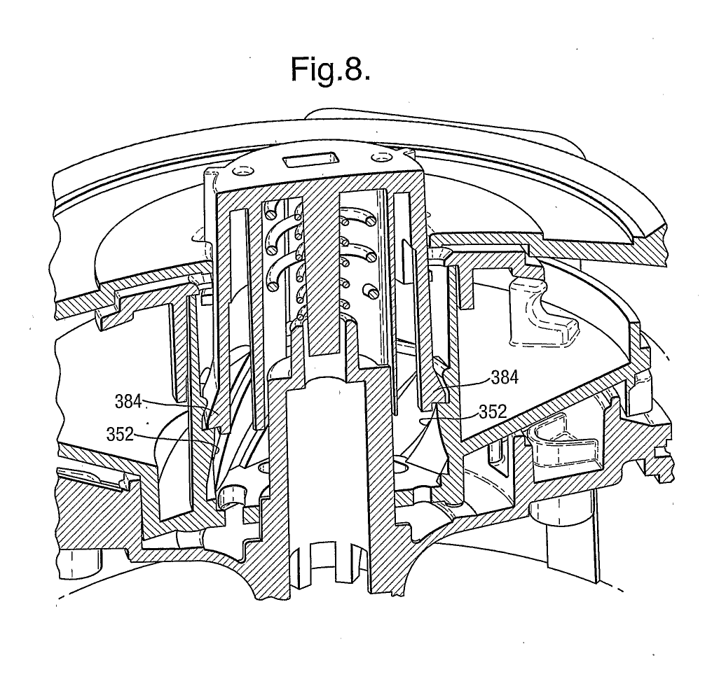

FIG. 8 is a further view of the device of FIGS. 6 and 7, showing movement of the device with a push button of the device depressed slightly;

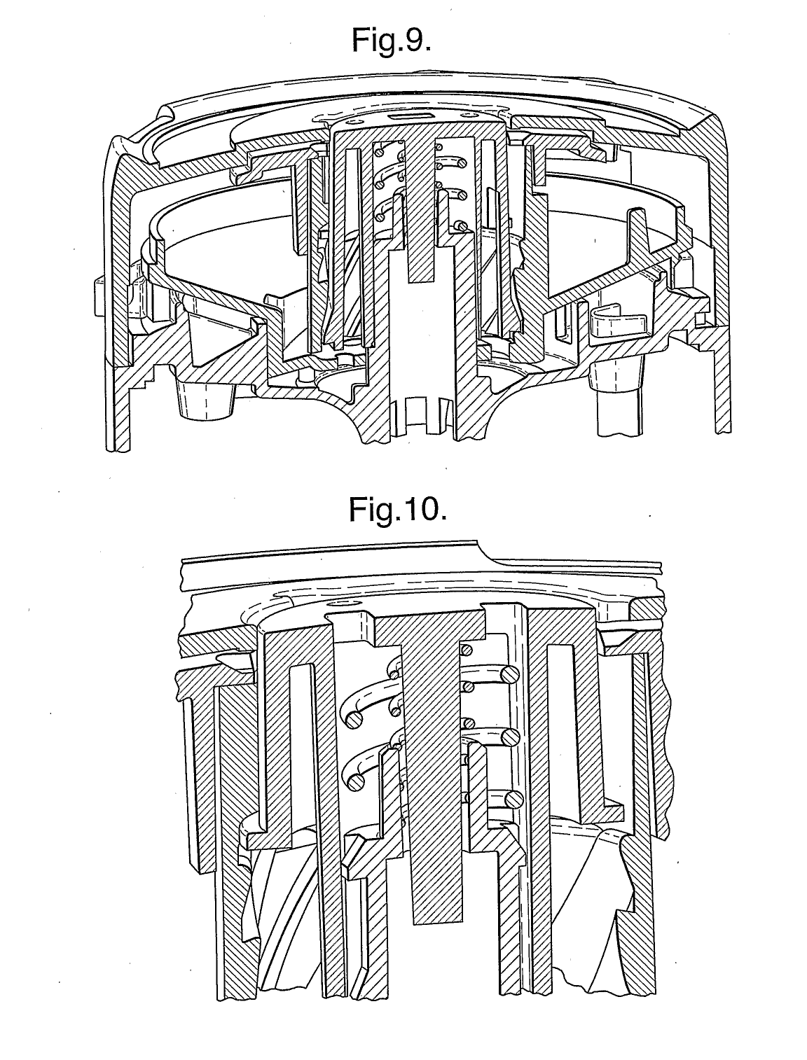

FIG. 9 illustrates the device of FIGS. 6 to 8, with the button fully depressed;

FIG. 10 shows detail of the device in the position shown in FIG. 9;

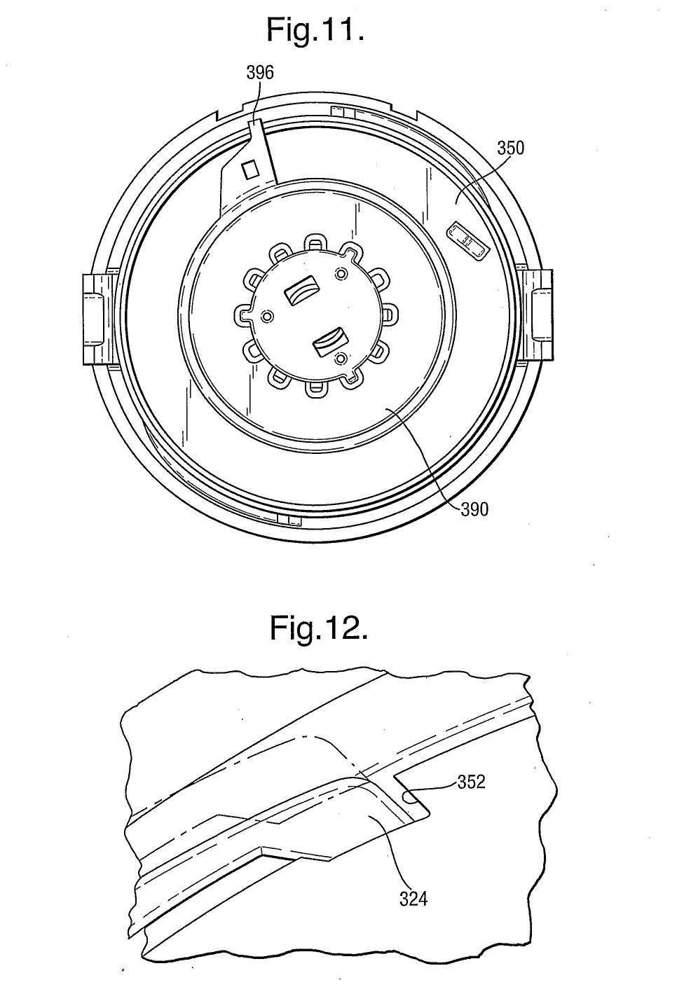

FIG. 11 shows an end stop mechanism associated with the device of FIGS. 6 to 10;

FIG. 12 shows a detent mechanism of the device of FIGS. 6 through 11;

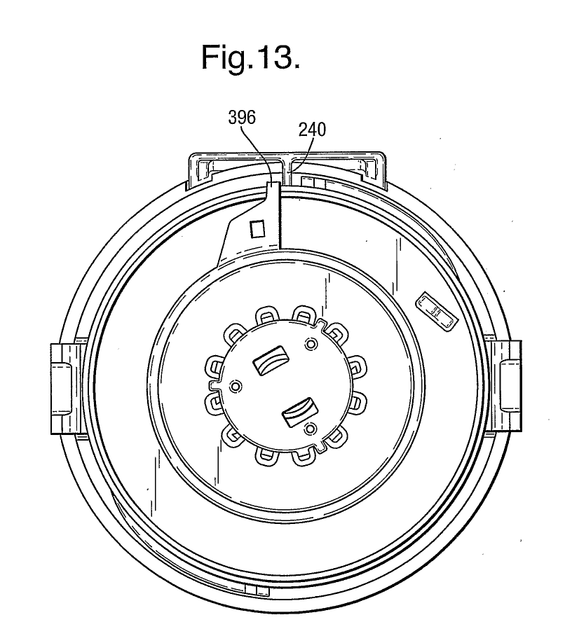

FIG. 13 shows detail of an end stop mechanism of the device, and its cooperation with an extension part of a lower portion of the device;

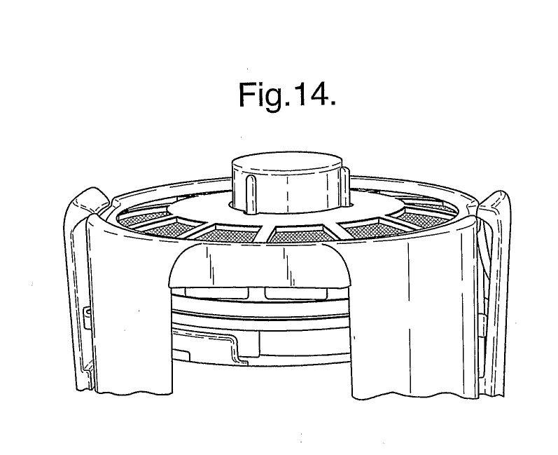

FIG. 14 is a view illustrating a lid portion of the device of FIGS. 6 to 12;

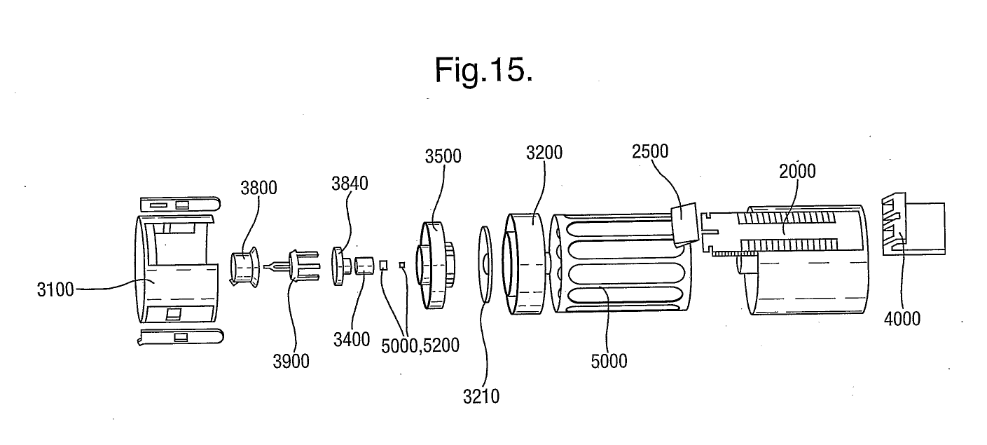

FIG. 15 is an exploded view showing components of an alternative embodiment of the device in which a thermo-sensitive magnet is employed; and

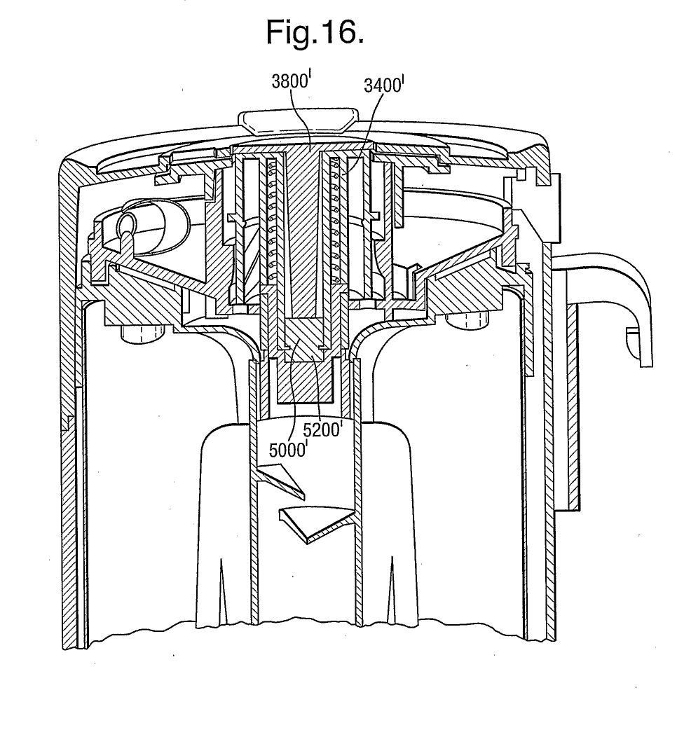

FIG. 16 is a cross-sectional view of a further embodiment of a device in accordance with the invention.

FIGS. 1(a), 1(b) and 1(c) show respectively assembled perspective front views, side view and a view with a lid portion removed of a detergent dispensing device 10 comprising a main housing 20, an upper portion 30 and a mounting device 40.

As shown in FIG. 1(c), the upper portion 30 is detachable from the main housing 20, and the main housing 20 is arranged to receive a refill cartridge 50 comprising a plurality of chambers 52, each of which contains a dosage element made up of cleaning composition. The cartridge 50 has twelve chambers 52, each occupying a 30 degree sector of the full 360 degrees of the cylindrical device 10. The dosage element of each chamber 52 is in solid form, and each chamber 52 is separated from its neighbour. Each chamber 52 has at least an upper hole and a lower hole (not shown), the upper hole being for receiving water/wash liquor collected by the upper portion 30, and directed to that upper hole during the course of a dishwashing cycle. The water/wash liquor dissolves the cleaning composition held within the chamber 52, and disperses it through the lower hole of the chamber 52.

The device of FIGS. 1(a) through 1(c), is arranged such that only a single chamber 52 of the refill cartridge 50 receives water/wash liquor during a dishwashing cycle.

The generalised components of the detergent dispensing device 10 are shown in more detail in FIG. 2. Here, the upper portion 30 is shown to comprise upper body portion 310, a chassis portion 320, a button return spring 340, a directing means comprising a funnel 350, a sieve portion 360, a thermally activated element in the form of shape memory alloy biasing means 370, push button 380 and an indicator dial 390. The main housing 20, as well as including the provision, for a mounting device 40 has a central shaft 210, for receiving onto it the refill cartridge 50. The shaft 210, features a number of dividing ribs 212; for separating (or fanning out), individual chambers 52 of the refill 50.

FIG. 3 shows, in cross-section, the assembled components detailed in FIG. 2. Here, it can be seen that at the base of the main housing 20, there is provided a water exit labyrinth 220, for directing water/wash liquor with dissolved or entrained particles of cleaning composition out of the device. It also can be seen that the button return spring 340, is held centrally within the chassis portion 320, and rests on a spring seat 322. The upper most part of the return spring 340, bears against a central shaft 382 of the push button 380, and acts so as to bias the push button 380 upwardly. Push button 380 itself, also includes an advance pawl 384, which acts so as to advance the funnel 350, (as will be described later) by cooperating with a funnel advance spiral 352, formed in an internal region of the funnel 350. The shape memory alloy biasing means 370, is provided externally of the central shaft 382 of the push button 380, and sits in a gap provided between an internal region of the push button 380, and an upper most central extent of the funnel portion 350.

It should be noted here that the push button 380, is constrained for movement within just the vertical plane, whilst the funnel 350 is able to rotate about a central axis of the device. The chassis 320 is a static item and the funnel 350 is rotatable upon the chassis 320. Accordingly, the reader will understand that depressing the push button 380, will cause the attached advance pawl 384, to also descend, this pawl 384, locates within the helix provided by advance spiral 352, which is attached to the funnel 350. Therefore, as the push button 380 is depressed, the funnel 350 will be rotated, by an amount dictated by the formation of the helix of the advance spiral 352.

The general principle of the cooperation of the various components listed above, is such that a hole formed in the funnel 350, is rotatably displaceable by 30°, for each push of the push button 380. Accordingly, 12 pushes of the button 380, will ensure a complete rotation of the funnel 350. Therefore, by providing a refill cartridge 50, having 12 chambers 52, located on shaft 210, with each chamber separated by ribs 212, it will be appreciated that the mechanism may be conveniently arranged so as to direct the aperture of the funnel 350, so as to be displaced from a position over upper apertures formed in each of the chambers 52, in a sequential manner.

By positioning the detergent dispensing device 10, on a suitable wire rack within a dishwashing machine, by means of the mounting device 40, a user can carry out a convenient dishwashing cycle, in which detergent is automatically dispensed by the device during the cycle, by water being collected in the upper portion of the device, so that water falling from the sieve region 360, is filtered and fed to the funnel 350, directed by the funnel 350 to a single chamber containing cleaning composition, cleaning composition from that chamber 52 is then dissolved or entrained and exits the device 10, through the exit labyrinth 220 and into the dishwashing machine.

Following a dishwashing cycle, the user may then press the button 380, so as to advance the funnel 350 and its associated directing means comprising the aperture formed in the funnel 350 to the next position, over the next neighbouring chamber 52. In this way, a user may conveniently carry out a series of 12 dishwashing cycles and then, following exhaustion of the device, the device may be refilled with a new refill cartridge 50 and a new set of 12 dishwashing cycles carried out.

The reader will appreciate that by providing a convenient static marking on the upper portion 30, and by linking motion of the indicator dial 390, to motion of the funnel 350, a user may keep track of how many of the chambers of cleaning composition making up the refill cartridge 50, remain before the refill needs to be replaced.

A general marking scheme and procedure for providing the above mentioned indication, is now discussed in relation to FIGS. 4(a) through (f). These Figures show the idealised movements of the push button 380, the funnel 350 and the indicator dial 390. The push button 380 includes ribs 386ₐ through 386_{c} and the indicator dial 390 includes slots 392 for cooperation with the ribs as will be described shortly.

Referring initially now to FIG. 4(a) there is shown a scenario in which only one detergent is left. This is indicated by the numeral 1 on the indicator dial 390, being aligned with an arrow 362, attached to the sieve portion 360.

In this final wash scenario; the user initially presses down the push button 380, into the position shown in FIG. 4(b). Indicator dial 390, is not fixedly linked to motion of the funnel 350, but is instead linked to motion of the funnel (as will be described later) by means of an indicator dial biasing spring which will be referred to as an EOL (End Of Life) spring. As there is no fixed movement relationship between the indicator dial 390 and the funnel 350, depression of the push button 380, causes the funnel 350 to advance, as mentioned earlier. However, the cooperation between the ribs 386ₐ, through, 386_{c}, and slots 392, formed at 30° intervals around the indicator dial 390, ensure that as the button 380 is pushed, the indicator dial 390 cannot move in direct cooperation with the funnel, but instead remains locked to its current position, still indicating one detergent left.

The button 380, once descended latches by latching means (not shown) to stay in the down position. The button 380 is maintained in this position also by virtue of the fact that the shape memory alloy biasing means 370 is at room temperature and is thereby in a short (or compressed) state. The SMA biasing spring 370 when in the compressed state is free floating within the hollow space at the top of the button 380 and exerts no restoring force against the latched button 380. The push button return spring 340 is relatively weak and, as such, is incapable of overcoming the latching mechanism on its' own. Therefore, once the push button is in the down position it will remain down. Latching of the push button 380 is used so as to prevent a user from double pushing the button 380 and causing double actuation of the advance mechanism. The SMA biasing spring only assumes a lengthened (or uncompressed) state at elevated temperatures such as would be experienced during a wash cycle (for example, 50° C.) and when such a temperature is reached, the force exerted by the SMA biasing spring 370 is sufficient to overcome the latching means and restore the push button 380 to the up condition.

As shown in FIG. 4(c), once the wash is underway and the temperature rises to 50° C., the SMA biasing spring lengthens and the button 380 rises. With the button 380 in the up position, ribs 386ₐ through 386_{c} are clear of slots 392 and the restoring force from the indicator dial biasing (EOL) spring acts so as to advance the indicator dial 390, toward the next indicator position. However, end stop means rigidly attached to the indicator dial 390 (and to be described later) contacts end stop means associated with the device 10, and rather than advancing the indicator dial by 30°, it instead only advances by 15°, toward an end stop position in which instead of aligning ribs 286ₐ, through 286_{c}, with corresponding slots 392, instead the under portion of ribs 386ₐ through 386_{c}, are blocked by protuberances spacing the slots 392.

In this way, whilst the releasing of the push button 380 by the SMA biasing spring 370 acts such that the ribs 386ₐ through 386_{c} rise above the slots 392, full movement of the dial 390 is not allowed and it can only move by a 15° rotation in a final wash cycle. This partial rotation also means that the lands between the slots 392, rather than the slots themselves, are aligned with the undersides of the ribs 386ₐ through 386_{c}, and any further downward motion of the push button 380 is thereby blocked. Accordingly, a user pressing the button again, when the device is in the empty position as shown in FIG. 4(c) is not possible.

Referring now to FIG. 4(d), the user will realise (by being unable to depress the button 380) that there are no more chambers 52, in a given cartridge 50 available. The user will then remove the upper portion of the device 10, from the main housing 20, to insert a new cartridge. The removal of the upper portion 30, from the main housing 20, releases the end stop mechanism of the indicator dial 390, from the post which was blocking further movement of the indicator dial 390, and thereby the indicator dial 390, advances by the required further 15°, to unlock the push button 380 by bringing the ribs 386ₐ through 386, back into alignment with corresponding slots 392. Accordingly, by pushing the button down again in FIG. 4(f), the funnel will be advanced, and then on release of the button 380 during the following wash cycle, the dial will advance to the next position showing 11 available washes and so on, all the way through the cycle again until the end stop mechanism is encountered once more.

In the above discussion in relation to FIGS. 4(a) through 4(f) the idealised steps of operating the device during an end of life cycle have been discussed, but the individual components are not all shown. Now the interaction of individual components of the end of life mechanism comprising indicator dial 390, EOL spring and end stop mechanism etc. required to bring about the above mentioned movements will be discussed in more detail, in relation to FIGS. 5(a) through 5(g).

Referring now to FIG. 5(a), there is shown in part sectional view an arrangement in which the push button 380 is in an “Up” state, and in which the indicator dial 390 indicates that there are two detergent washes left. Here, it can be seen that there is a compression spring, which is the indicator dial biasing spring, also referred to herein as the EOL spring 394. In the position shown, the spring is fully extended, and extends between the indicator dial 390 and part of the funnel 350. There is also shown an end stop arm 396 which is an integral part of the indicator dial 390, and extends circumferentially from below the indicator dial 390.

Referring now to FIG. 5(b), there is shown the situation where the button 380 has been depressed. In this situation, as explained earlier with reference to FIG. 4, the pushing down of the button 380, drives the funnel 350, 30° forward. However, the interaction between ribs 386ₐ through 386_{c}, and slots 392, ensure that in this position, the dial 390, and also of course the associated end stop arm 396 do not yet progress. In this point though, the movement of the funnel 350, and the non-movement of the indicator dial 390, acts so as to compress the EOL spring 394. The shape memory alloy biasing spring 370 is in a compressed state and the push button 380 is latched “Down”.

When the button is released during the wash by the expansion of the SMA biasing spring 370, as, shown in FIG. 5(c), the ribs 386ₐ through 386_{c}, become disengaged from the slots 392 at the top of the range of travel of the push button 380. This disengagement allows the indicator dial 390 and associated end stop arm 396 to be advanced by the releasing of the pressure in the EOL spring 394. In this situation, the dial 390 is progressed so as to show that there is one detergent dose left.

Now, referring to FIG. 5(d), there is shown, in similar fashion to FIG. 5(b), what happens when the button 380 is pressed again. Once more, the funnel 350 turns through 30° whilst the indicator dial 390, cannot move as it is locked by the cooperation of the ribs and slots, and in this case the EOL spring 394 is again compressed. When the button is released from its latched down state by the SMA biasing spring 370 as shown in FIG. 5(e), it will be appreciated that the indicator dial 390, is then released and, under action from the EOL spring 394, the indicator dial is driven forward. However, in this position, the end stop arm 396, comes to abutment against post 240, which extends from the main (lower) housing 20. This post 240, impedes further movement of the end stop arm 396, and does not allow the indicator dial 390 to go beyond the red line, indicating that renewal of the cartridge 50 is required.

Referring now to FIG. 5(f), there is shown a position in which the top parts of the device, are lifted away from the main housing 200, so as to insert a new refill. As the funnel 350, indicator dial 390, push button 380 and all of the associated components are removed from the main housing 20, the end stop arm 396, comes clear of post 340. Under that condition, the EOL spring 394, is able to fully uncompress and move forward to indicate that there are now 12 washes available with the device. Accordingly, when the lid is replaced in step 5(g), the end stop arm 396, is advanced past the position of the post 240, and a further 12 cycles may be carried out before resetting and refilling needs to be tackled again.

In the above description, an embodiment for providing the indication of remaining washes, and for providing an end stop mechanism has been discussed.

We will now refer to a further embodiment with reference to FIGS. 6 to 16. In the discussion relating to this next embodiment, like numerals will be utilised, and it will be noted that certain components such as the EOL spring 396, are not shown. However, it will be appreciated that, in fact, such a spring is present and its location may be similar or identical to that shown and discussed with regard to the preceding embodiment.

It will also be appreciated that whilst in the preceding embodiment, the EOL spring 396 was a compression spring, a tension spring may instead be used by varying fixation points. For example, with a compression spring the EOL spring 396 is suitably connected at a forward end to the dial 390 and at a rearward end to the funnel 350 so as to push the dial 390 forward after push button 380 is released. In contrast, with a tension spring the EOL spring is connected so as to have a forward end thereof attached to the funnel 350 and a rearward end connected to the dial 390 so as to pull the dial 390 forward after push button 380 is released.

For ease of explanation, where operations in embodiments are identical, they will not be fully discussed, but may be assumed to be identical to the operations carried out in the already discussed embodiment.

Referring now to FIG. 6, in this embodiment, there is shown push button 380, funnel 350, indicator dial 390, push button spring 340, chassis member 320, SMA biasing means 370 and a cover 400, having a window 420, through which a numeral on the indicator dial 390, may be observed. Here, it will be appreciated that the cover 400, acts as a lid, and carries the various portions carried in the previous example by the upper body portion 30.

FIG. 6 shows a start position, prior to carrying out a wash. In this position, the button 380 is held in position by the cooperation of its associated funnel advance pawl 384 (not shown) engaging with a lip portion at the top of the funnel advance spiral 352, and is biased into the up position, by the push button return spring 340. It also cannot advance any further, as it is held in position by the underside of the indicator dial 390. Here, the button in fact lifts the indicator dial 390, by a small amount. Thereby, the main push button return spring 340, is pushing the push button 380 upwardly, the SMA biasing means 370 is free floating and all in is a stable position.

Referring now to FIG. 7, there is shown the same assembly, but with the cover 400 removed for ease of understanding motion of the device. In this position, push button 380, indicator dial 390 and associated end stop arm 396 can be seen more clearly. Here, it is noted of course that the ribs 386ₐ through 386_{c}, are clear of the slots 392, but in registration with them. In this position, the indicator dial 390 is in a correct position to allow the push button 380 to descend when pushed.

Now, referring to FIG. 8, there is shown the next position, with the cover 400 in place. In this position, the button has been slightly depressed, so that the pawl 384, is engaging with the funnel advance spiral 352, so as to push the spiral slightly forward. In this position, the indicator dial 390, now rather than being biased upwardly by the push button 380, rests on the funnel 350.

Referring now to FIG. 9, there is shown the position with the push button 380 fully depressed. Here, the button 380 now rests against the chassis 320 in the circled region of FIG. 9, and is prevented from descending any further. The funnel advance pawl 384, comprises of two legs 384a, 384b and these legs have acted to drive the funnel forward, and to stop it at the correct position when the button hits the chassis in the circled region shown. At this point, the indicator dial 390 has not moved yet, as rotation of that dial is prevented by interaction of the ribs on the button, and the slots in the dial. The button is held in place by the cover 400, and the chassis 320. Here, as shown in the inset view of FIG. 10, (where the funnel advance pawl 384 is omitted for a clearer view) it can be seen that the push button return spring 340 is fully compressed, whilst the SMA biasing means 370 is also compressed. The push button 380 is maintained in the down position by the latching means shown circled. The EOL spring (not shown) is in a position ready to advance the dial 390, as the funnel has already advanced, but the indicator dial 390 is not yet able to advance due to the slot/rib co-operations described earlier. Here, the EOL spring is, rather than being a compression spring, preferably an extension spring. Thereby, movement first of the funnel, extends the EOL spring, so that when the EOL dial is then able to move after button release by means of the SMA spring 370, the indicator dial 390 is pulled forwardly by the EOL spring.

FIG. 11 is a plan view of the situation shown in FIGS. 9 and 10, but with the cover 400 removed. Here, the indicator dial 390 and its associated end stop arm 396 is shown clearly, above the funnel member 350.

There is shown in FIG. 12 how a spring leg 324 of the chassis 320 cooperates with a detent 352 of the funnel 6350. The funnel 350 is formed with such detent positions 352 regularly spaced at 30 degree intervals around its periphery. This works so that as the button 380 descends, the funnel 350 moves (rotates) so as to cause spring leg 324 of chassis 320 to release from its detent position, and then rotate to a new detent position 30° further on, when spring leg 324 engages with this new detent 352. Thereby, movements of 30° per button push may be carried out in a reliable manner.

The detent formations 352 co-operating with the chassis leg 324 prevent back driving of the funnel wherein the push button 380 is released by the SMA biasing spring 370. In this way, once the push button 380 releases, it is driven vertically upward and effectively drags the funnel 350 with it upwardly (but does not rotate the funnel due to the co-operation of detent 352 and leg 324) by a small amount until it compresses the indicator dial 390 to the lid bezel, at which point the force of the SMA biasing spring 370 causes the pawl legs 384 to jump out of the helix 352 and release the funnel 350. In this manner, forward motion of the funnel is properly assured upon button depression without any back driving occurring upon button release.

Referring now to FIG. 13 and FIG. 14, there is now shown an end of life situation in which in FIG. 13, it is shown how an end stop mechanism works by the cooperation of end stop arm 396 with an extension post 240. The extension post 240 forms an extension of the lower body portion 20.

This end stop mechanism is identical in working to the end stop mechanism as described earlier with regard to the first embodiment and will not be described in any further detail herein.

As with the first embodiment, removal of the upper body portion 310 of the device allows end stop arm 396 to move forward by the further 15° step.

FIG. 14 illustrates, schematically, the fact that the upper body portion 310, may have a cut-out area into which the main body portion 240 normally extends. Therefore, when clip means associated with the upper body portion 310 are released, and the upper body portion is separated from the main housing 20, the end stop arm 396 may be brought away from the extension post 240 and resetting of the mechanism occurs automatically.

Referring now to FIG. 15, there will be described a modified embodiment of the invention in which there is shown and described an alternative mechanism for preventing double actuation of the push button 380.

In the modified arrangements, instead of using an SMA spring 370 and various latching mechanisms between a leg extension of the button 380 and a part of the chassis of the device, there is used a thermo-sensitive magnet device. In general principle, a thermo-sensitive magnet retains the push button in a down state within a first temperature range and, outside of that range the device loses a large degree of magnetism to allow the button to return to the up state, aided by spring return means.

In FIG. 15 there is shown an upper body portion 3100, push button 3800, indicator dial 3900, directional gear 3840, push button return spring 3400, first and second members 5000, 5200, funnel 3500, a chassis cover member 3210, chassis 3200, refill cartridge 5000, main housing 2000, stopper 2500 and clip 4000.

The upper body portion 3100, push button 3800, indicator dial 3900, return spring 3400, funnel 3500, chassis 3200, refill cartridge 5000, main housing 2000 and clip 4000 are similar in construction and function to their equivalent features 31, 38, 39, 34, 35, 32, 50, 20 and 40 respectively of the first embodiment and need not be described again in detail.

We will now describe the form and function of the device of the second embodiment in more detail.

The device comprises upper and lower parts. The upper part is a water inlet part having an indexing mechanism to control turning of the funnel 3500 so as to align a funnel vent with a particular one of a detergent cartridge of the refill 5000, whilst the lower part is effectively a housing to hold the refill in position.

The funnel 3500 sits atop the chassis assembly comprising cover 3210 and chassis 3200 (the cover 3210 being sonic welded to the chassis 3200 to form an integrated element). The funnel 3500 includes the directional gear 3840 and this slots into a hub area of the funnel 3500, whilst the push button 3800 is transparent and assembles onto the directional gear 3840 with indicator dial 3900 sitting between the two. The second member 5200 is installed at the chassis centre.

Each chamber of the chassis assembly has an inlet and an outlet to align with the vent of the funnel 3500 and a hole formed in an individual detergent dosage element. A number relating to which refill is currently aligned with the funnel is indicated at the top of the device by means of the transparent part of the push button 3800, the indicator dial 3900, the directional gear 3840, and the thermo-sensitive magnet of the first member 5000.

In FIG. 15, the return spring 3400 is shown as being a stainless steel spring situated around an extension part of the directional gear 3840 to lie between the indicator dial 3900 and the chassis assembly 3210/3200.

In the lower part of the device, the main housing 2000, includes mounting clip 4000 and stopper 2500. The clip 4000 snaps onto a rack of the housing 2000 for the user to adjust the hanging position of the device within a dishwasher. The stopper 2500 is assembled on the top of the rack of the housing 2000 and has two functions: (1) as a guide rib to aid the user assembling the upper and lower parts; and (2) as an indication to the user to replace the refill when an outwardly extending side piece of the knob (not shown) comes into contact with it to stop rotation.

In use, the refill pack is assembled into the housing 2000 and the upper and lower parts brought into registration and clipped together. Before starting a wash, the push button 3800 is depressed which activates the device by the directional gear 3840, turning the funnel to align the funnel vent with a first chamber containing detergent. Simultaneously, the first and second members come together at the bottom of the down stroke and the magnetic force between them holds the push button in the down state.

The device is then put into the dishwasher and a washing cycle is commenced. Hot water flows into the device and the detergent is washed from the aligned dosage element into the dishwasher. When the thermo-sensitive element comprising the first member reaches a temperature of around 45 degrees Celsius the magnetic force exerted by it reduces and the first and second members separate under action of the return spring 3400. At this point, the push button 3800 ascends into the up state and turning of the funnel can once again be enabled by a user prior to the next wash. Following a 12^{th} cycle, the rotation of the push button is stopped by the stopper 2500 and this serves as an indication to the user that a new refill is needed.

Referring now to FIG. 16, there is shown another embodiment of a device incorporating the two magnetic members in cross section and in an assembled state. Here, this device is a variation upon the device of the first embodiment and uses a pawl and helix advance mechanism. However, instead of a mechanical latch and SMA member, the device includes the use of a thermo-sensitive first magnetic member 5000′ directly attached to an extension of the push button 3800′ and a second permanent magnetic member 5200′ within a central part of chassis 3200′. In this way, when the push button 3800′ is depressed, the first and second members are in close proximity. The members 5000′/5200′ are arranged to attract one another at commonly found room temperatures. The attractive force of the first and second members is arranged to be greater than a restoring force supplied by the return spring 3400′ such that the push button 3800′, once depressed, remains down in the state shown until temperatures within the device rise to 45 degrees or so at which time the button 3800′ is freed to return to the up state under action of spring 3400′.

In preferred embodiments, the thermo-sensitive magnet of the embodiments of FIGS. 15 and 16 has the following characteristics: (1) Material is thermosensitive magnetic ferrite; (2) The Curie point is 45° C.±2° C.; (3) The maximum magnetic permeability is greater than 3000 μN/A² and may be above 4000 μN/A²; (4) The rate of change of magnetic permeability around the Curie point is preferred to be around 140 μN/A²/° C.

After the device has cooled down following the execution/completion of a wash cycle, the push button of the device may once again be utilised by a user to advance the mechanism and latch the button in the down position.

The reader will appreciate that various numerations may be made without departing from the scope of the invention. In particular, whilst the positions of the first and second members on the device of the second and third embodiments may be reversed. Also, whilst the second magnetic member is described as being a permanent magnet, it could in certain circumstances where device forces permit be replaced by a piece of magnetisable material such as iron. Various different lid designs, main body housing and indexing mechanism designs may be made and still function within the general principles of the present invention.

1. A multi-dosing detergent delivery device, the device comprising: a housing for receiving therein a cartridge having a plurality X of chambers each accommodating a detergent composition; a water/wash liquor collection area for receiving and collecting water or wash liquor falling upon it; directing means for directing said water/wash liquor selectively into an inlet hole of a chamber of the cartridge to contact the detergent composition therein; and an outlet to allow the detergent loaded wash liquor to exit the device, the device further comprising push button operated indexing means for causing movement of said directing means relative to said cartridge so as to cause sequential movement of said directing means from directing water/wash liquor from one chamber to directing it to a neighbouring chamber and wherein means are provided for maintaining said push button in a “Down” state once it has been depressed and a return means for restoring said push button to an “Up” state after a washing cycle has been commenced.

2. The device according to claim 1, wherein said means for maintaining said push button in said “Down” state comprises a first member associated with said push button and a second member associated with a chassis member of said device.

3. The device according to claim 1, wherein said means for maintaining said push button in a “Down” state comprises latching means.

4. The device according to claim 3, wherein said latching means comprises the co-operation of a leg of said push button with a protuberance formed on a chassis member of the device.

5. The device according to claim 3, wherein said return means comprises a thermally activated member which, when heated to an activation temperature acts to defeat said latching means and return said push button to an “Up” state.

6. The device according to of claim 5, wherein said thermally activated member comprises a Shape Memory Alloy member.

7. The device according to claim 6, wherein said thermally activated member comprises resilient biasing means.

8. The device according to claim 5, wherein said return means comprises a return spring mechanism that expands upon heating to cause said push button to return to an “Up” state.

9. The device according to claim 2, wherein said means for maintaining said push button in said “Down” state comprises first and second magnetic or magnetisable members.

10. The device according to claim 9, wherein said first magnetic or magnetisable member is associated with said push button and the second magnetic or magnetisable member is associated with the chassis member.

11. The device according to claim 10, wherein one of said first or second magnetic or magnetisable members comprises a thermo-sensitive magnetic member and the other of said first or second magnetic members comprises either a permanent magnet or a ferro-magnetic material.

12. The device according to claim 11, wherein said thermo-sensitive magnetic member is arranged so as to be magnetically attracted to said permanent magnet or ferro-magnetic material at room temperature ranges, but to have reduced magnetic attraction at higher temperatures commonly encountered during washing cycles.

13. The device according to claim 12, wherein said thermo-sensitive magnetic member has a Curie point at approximately 43° C.

14. The device according to claim 9, wherein the return means comprises spring return means for returning said push button to the “Up” state when there is reduced magnetic attraction between said first and second magnetic or magnetisable members.

15. (canceled)
